(19) United States
(12) Patent Application Publication
(10) Pub. No.: US 2001/0013083 A1
(43) Pub. Date: Aug. 9, 2001

(54) Information processing apparatus and method and program storage medium

(76) Inventor: Ikuo Nakamura, Tokyo (JP)

Correspondence Address: FROMMER LAWRENCE & HAUG, 745 FIFTH AVENUE, NEW YORK, NY, 10151, US

(21) Appl. No.: 09/732,500

(22) Filed: Dec. 7, 2000

(30) Foreign Application Priority Data
Dec. 8, 1999 (JP) 11-348581

(51) Int. Cl. G06F 12/00

(52) U.S. Cl. 711/111; 713/300; 345/700

(57) ABSTRACT

An information processing apparatus and method and a program storage medium are provided wherein a plurality of devices of the same type connected to each other by a network can be used as a single multi-connection apparatus. A Multi AVDISCFCM issues an instruction based on a process of an application program of an IRD to each AVDISCFCM to read out contents management information recorded on a recording medium loaded on each MD drive to produce an inner table. Further, the Multi AVDISCFCM issues an instruction to one of AVDISCFCMs to play back the predetermined tack recorded on said recording medium based on said contents management information selected by a user through GUI from said inner table. The AVDISCFCM outputs an AV/C command to the corresponding MD drive to play back the predetermined tack. The MD drive plays back the designated track recorded on the recording medium loaded on each MD drive in accordance with the AV/D command.

### BACKGROUND OF THE INVENTION

This invention relates to an information processing apparatus and method and a program storage medium, and more particularly to an information processing apparatus and method and a storage medium for a system wherein a plurality of electronic apparatus are connected to each other by a network.

A scheme which makes use of a home network system configured using an IEEE 1394 serial bus is being popularized. In the home network system which is configured using an IEEE 1394 serial bus, a plurality of information apparatus of the same type such as, for example, MD (Mini Disc) drives can be connected to an information processing apparatus such as, for example, an IRD (Integrated Receiver Decoder) so that the information processing apparatus controls the plurality of information apparatus to record or play back information.

However, the home network system described above has a subject to be solved in that, although the information apparatus of the same type can be controlled individually, they cannot be controlled as a single virtual multi-connection information apparatus.

### SUMMARY OF THE INVENTION

It is an object of the present invention to provide an information processing apparatus and method and a program storage medium wherein a plurality of information apparatus of the same type can be used as a single multi-connection information apparatus to facilitate operation and management of the information apparatus.

In order to attain the object described above, according to an aspect of the present invention, there is provided an information processing apparatus, comprising recording medium information acquisition means for acquiring information of recording media loaded in a plurality of information apparatus connected to each other by a network, storage and management means for storing and managing the information of the recording media acquired by the recording medium information acquisition means in a concentrated manner, and control means for controlling the plurality of information apparatus based on the information of the recording media stored in the storage and management means.

Preferably, the information processing apparatus further comprises control information acquisition means for acquiring control information to be used to control the plurality of information apparatus individually from the information apparatus through the network, and the control means controls the plurality of information apparatus based on the control information acquired by the control information acquisition means.

The recording media may only allow playback thereof or allow both of recording and playback thereof.

The network may be formed from an IEEE 1394 serial bus.

Preferably, the information processing apparatus further comprises display means for displaying the information of the recording media stored in the storage and management means, and selection means for selecting the information of the recording media displayed on the display means, and the control means controls the information apparatus in response to those contents of the information of the recording media displayed on the display means which have been selected by the selection means.

When power supply to any of the information apparatus is connected, when any of the information apparatus is plug-in connected, when a recording medium is loaded into any of the information apparatus or when contents are recorded onto any of the recording media, the storage and management means may store the information of the recording medium acquired by the recording media information acquisition means.

When power supply to any of the information apparatus is disconnected, when any of the information apparatus is unplugged, when a recording medium is unloaded from any of the information apparatus or when contents are erased from any of the recording media, the storage and management means may erase the information of the recording medium stored therein.

The information of each of the recording media may be recorded contents management information of the recording medium and include a device ID, track numbers, track names, recording times, a HAVi media format or a MIC.

The information processing apparatus may further comprise apparatus type information acquisition means for acquiring apparatus type information of the plurality of information apparatus connected to each other by the network.

In this instance, the type of each of the information apparatus may be identified with a type of a FCM of the same.

The plurality of information apparatus include information apparatus of the same type.

According to another aspect of the present invention, there is provided an information processing method, comprising a recording medium information acquisition step of acquiring information of recording media loaded in a plurality of information apparatus connected to each other by a network, a storage and management step of storing and managing the information of the recording media acquired by the processing of the recording medium information acquisition step in a concentrated manner, and a control step of controlling the plurality of information apparatus based on the information of the recording media stored by the processing of the storage and management step.

According to a further aspect of the present invention, there is provided a program storage medium in which a computer-readable program is recorded, the program comprising a recording medium information acquisition controlling step of controlling acquisition of information of recording media loaded in a plurality of information apparatus connected to each other by a network, a storage and management controlling step of controlling storage and management of the information of the recording media acquired by the processing of the recording medium information acquisition controlling step in a concentrated manner, and a control step of controlling the plurality of information apparatus based on the information of the recording media stored by the processing of the storage and management controlling step.

In the information processing apparatus and method and the recording medium, information of recording media loaded in a plurality of information apparatus connected to each other by a network is acquired, and the acquired information of the recording media is stored and managed in a concentrated manner. Then, the plurality of information apparatus are controlled based on the stored information of the recording media. Consequently, the plurality of information apparatus can be used as a single virtual multi-connection apparatus, and operation and management of information of the information apparatus can be facilitated.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a block diagram showing a construction of a network system to which the present invention is applied;

FIG. 2 is a block diagram showing a detailed construction of an IRD shown in FIG. 1;

FIG. 3 is a block diagram showing a detailed construction of a MD drive shown in FIG. 1;

FIG. 4 is a schematic view illustrating software stored in a hard disc drive shown in FIG. 2;

FIG. 5 is a table illustrating an inner table;

FIGS. 6 and 7 are schematic views showing examples of GUI displayed on a monitor shown in FIG. 2;

FIG. 8 is a schematic view showing a GUI displayed on the monitor shown in FIG. 2 when an addition registration button is clicked;

FIG. 9 is a similar view showing a GUI displayed on the monitor shown in FIG. 2 when a registration deletion button is clicked;

FIG. 10 is a flow chart illustrating a network management process;

FIGS. 11 to 13 are flow charts illustrating operation when an inner table is produced;

FIG. 14 is a schematic view showing a GUI displayed as an initial screen when an inner table is produced;

FIG. 15 is a flow chart illustrating operation when a track designated by the IRD of FIG. 2 is played back;

FIG. 16 is a flow chart illustrating operation when the MD drive of FIG. 3 performs a playback process;

FIG. 17 is a flow chart illustrating operation when the IRD of FIG. 2 performs a random process;

FIG. 18 is a flow chart illustrating operation when the IRD of FIG. 2 performs a random playback process;

FIG. 19 is a flow chart illustrating operation when the IRD of FIG. 2 changes and plays back a track;

FIG. 20 is a flow chart illustrating operation when the IRD of FIG. 2 changes and plays back a disc;

FIG. 21 is a flow chart illustrating operation when the IRD of FIG. 2 plays back in a repeat state; and

FIG. 22 is a flow chart illustrating operation when the IRD of FIG. 2 performs a media information management process.

### DESCRIPTION OF THE PREFERRED EMBODIMENT

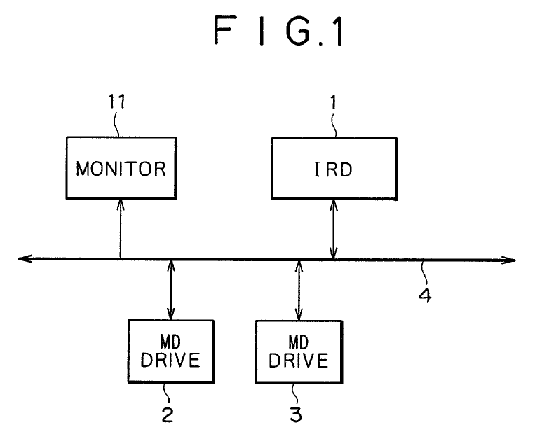

Referring first to FIG. 1, there is shown a construction of a network system wherein a plurality of amplification apparatus are connected to an information processing apparatus.

An IRD 1 receives a broadcasting signal from a satellite not shown by means of an antenna not shown and demodulates the broadcasting signal to obtain an image, which is displayed on a monitor 11. Further, the IRD 1 extracts an audio signal from the received broadcasting signal and outputs the audio signal to MD drives 2 and 3 over an IEEE 1394 serial bus 4. The IDR 1 further controls the MD drives 2 and 3.

The MD drive 2 can accept two MDs while the MD drive 3 can accept one MD. When any of the MD drives 2 and 3 is connected to the IEEE 1394 serial bus 4, it transmits a DCM (Device Control Module) and a FCM (Functional Component Module) of the device itself to the IRD 1 over the IEEE 1394 serial bus 4. Details of the DCM and the FCM are hereinafter described.

The IRD 1 receives DCMs and FCMs sent thereto from the MD drives 2 and 3 and detects apparatus control information of those devices which are connected to the IEEE 1394 serial bus 4 from the DCMs and the FCMs. Then, the IRD 1 controls the monitor 11 to display a GUI (Graphical User Interface) for controlling the devices connected to the IEEE 1394 serial bus 4.

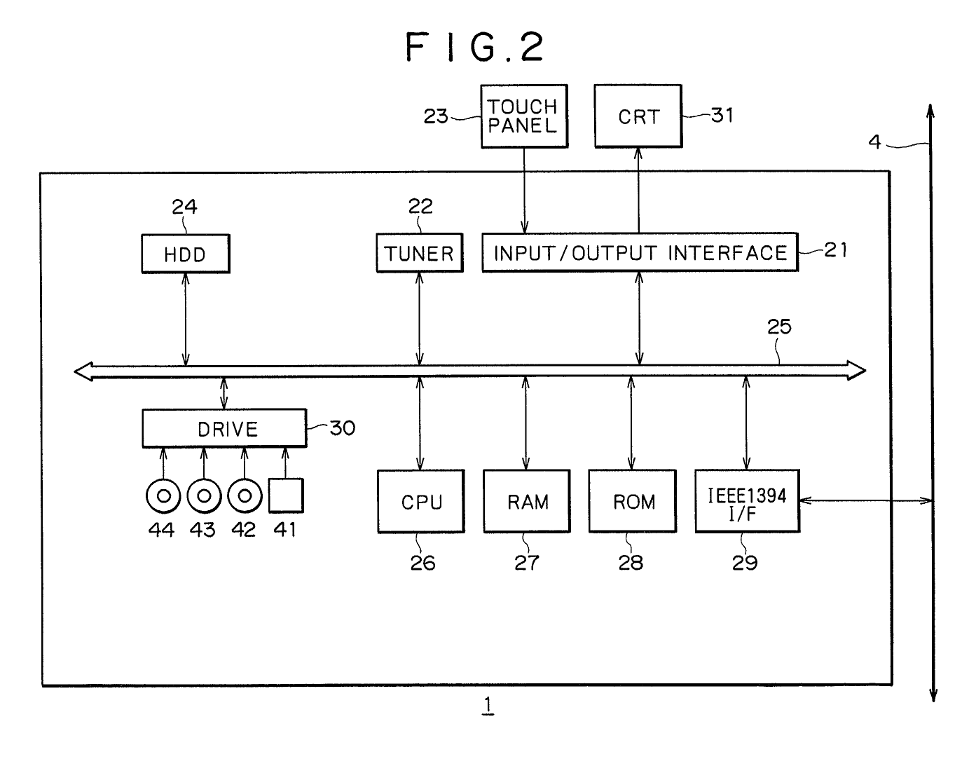

FIG. 2 shows a detailed construction of the IRD 1. Referring to FIG. 2, an input/output interface 21 functions as an interface for a signal to be outputted to a CRT (Cathode Ray Tube) 31 and another signal inputted from a touch panel 23 and is connected to an internal bus 25.

A tuner 22 demodulates a broadcasting signal and outputs the demodulated broadcasting signal through the internal bus 25, an IEEE 1394 I/F (interface) 29 and the IEEE 1394 serial bus 4 to the monitor 11.

The touch panel 23 is provided on the surface of a body of the IRD 1. If a user operates the touch panel 23 in response to a display of the CRT 31 or the monitor 11, then a CPU (Central Processing Unit) 26 produces a control signal in response to the operation of the touch panel 23 and issues various instructions to the MD drives 2 and 3 over the IEEE 1394 serial bus 4. Further, contents of the instructions are displayed on the CRT 31 through the input/output interface 21. Each of the MD drives 2 and 3 executes processing such as transmission or reception of data over the IEEE 1394 serial bus 4 or playback or recording of sound data and so forth in accordance with the control signal inputted thereto.

A HDD (Hard Disc Drive) 24 has stored therein application programs to be executed by the CPU 26, middle ware and so forth.

The internal bus 25 interconnects the input/output interface 21, the tuner 22, the HDD 24, the CPU 26, a RAM (Random Access Memory) 27, a ROM (Read Only Memory) 28 and the IEEE 1394 interface 29 to allow communication of data between them.

The CPU 26 controls operation of the entire IRD 1 and executes various application programs when necessary. Into the RAM 27, various application programs to be executed by the CPU 26 and latest information necessary for execution of processing by devices connected to the IEEE 1394 serial bus 4 by processing which is hereinafter described are written. The ROM 28 has stored therein a program for loading and starting up an OS (Operation System) and so forth necessary for processing of the CPU 26. The IEEE 1394 interface 29 functions as an interface with the IEEE 1394 serial bus 4 and executes communication of data with the IEEE 1394 serial bus 4.

Into a drive 30, a semiconductor memory 41, a magneto-optical disc 42, an optical disc 43, a magnetic disc 44 and so forth can be loaded.

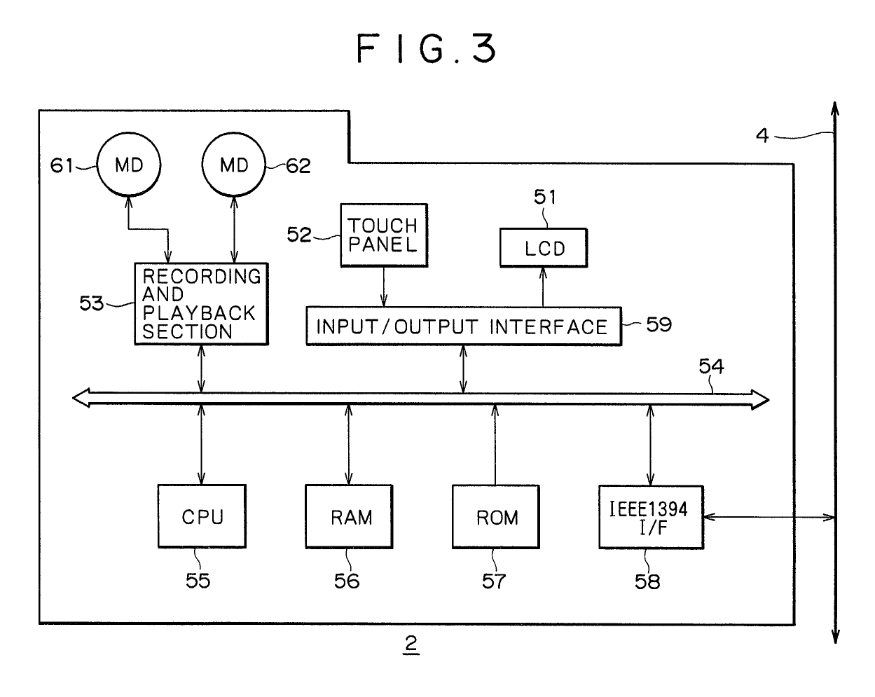

FIG. 3 shows an internal construction of the MD drive 2. A signal transmitted from the IRD 1 is inputted to a CPU 55 through the IEEE 1394 serial bus 4, an IEEE 1394 interface 58 and an internal bus 54. Further, if a user observes display contents displayed on a LCD (Liquid Crystal Display) unit 51 and operates a touch panel 52, then a signal representative of the operation of the user is inputted to the CPU 55 through an input/output interface 59 and the internal bus 54, and the CPU 55 controls a recording and playback section 53 in accordance with the signal.

The recording and playback section 53 records data inputted thereto through the IEEE 1394 interface 58 and the IEEE 1394 serial bus 4 onto a MD 61 or 62 loaded therein or reads out data recorded on the MD 61 or 62 and transmits the data through the internal bus 54, IEEE 1394 interface 58 and IEEE 1394 serial bus 4 to an amplifier or the like not shown connected to the network in accordance with a control signal inputted thereto from the CPU 55. The recording and playback section 53 further outputs data read out from the MD 61 or 62 such as a track name which is hereinafter described through the internal bus 54 and the input/output interface 59 so that the data may be displayed on the LCD 51.

The CPU 55 reads out a program stored in a ROM 57 in accordance with a signal inputted thereto, expands the program in a RAM 56 and executes the program to output a control signal to the recording and playback section 53 over the internal bus 54 or transmit the DCM and the FCM of the MD drive 2 itself to the IRD 1 through the internal bus 54, IEEE 1394 interface 58 and IEEE 1394 serial bus 4. The RAM 56 temporarily stores data produced upon execution of a program by the CPU 55 or data necessary for execution of processing by the MD drive 2 and so forth.

The MD drive 3 has a similar construction to that of the MD drive 2 described hereinabove with reference to FIG. 3 except that it can accept a single MD while the MD drive 2 can accept two MDs. Thus, overlapping description of the MD drive 3 is omitted herein to avoid redundancy.

In order to allow such devices on the network as shown in FIG. 1 to operate cooperatively, middle ware for control and management of the network, that is, software which is positioned between lower software such as an OS (Operating System), a network control program or a database system and an upper application and provides various services to the application, is required. Also where devices of different makers are connected to the network, in order to allow the network to operate normally to achieve mutual operation of the devices, common specifications with which the middle ware complies are essentially required. Here, a network system is described wherein the HAVi (trademark) (Home Audio/Video Interoperability Architecture) is applied as the middle ware for control and management of the network.

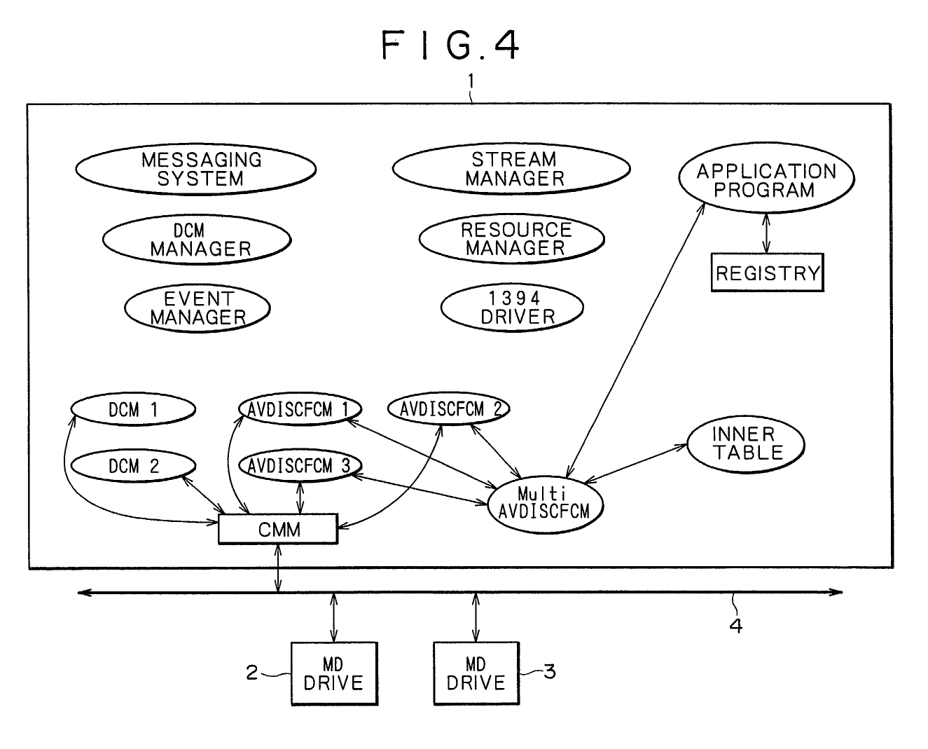

FIG. 4 illustrates an example of software stored in the hard disc drive 24 shown in FIG. 2. Of elements shown in FIG. 4, those elements except a 1394 driver and an application program serve as software modules compliant with the HAVi.

The 1394 driver is a module which describes portions which rely upon the IEEE 1394 serial bus 4 and is software for providing a common procedure for device accessing to the upper software.

A CMM (Communication Media Manager) serves as an interface between the IEEE 1394 serial bus 4 and the software modules of the HAVi and applications. The CMM provides a transmission mechanism for communication of a signal between devices connected to the IEEE 1394 serial bus 4, and grasps an operation situation of the IEEE 1394 serial bus 4 and provides information of the operation situation to the other software modules.

A messaging system serves as an API (Application Programming Interface) for allowing communication between the software modules of the devices on the network and acts to transmit a message between the software modules. Therefore, the network which adopts the HAVi allocates, to each of software elements in the same device, a SEID (Software Element Identifier: an identifier value of the software element) and thus allows a transmission side and a reception side of a message to communicate the message without knowing the locations of the other sides on the network.

A DCM (Device Control Module) manager installs a DCM and a FCM (Functional Component Module) corresponding to each of the devices on the network. If a new device is connected to the network which adopts the HAVi, then the DCM manager installs a DCM and a FCM corresponding to the newly connected device. However, if a device is disconnected from the network, then the DCM manager uninstalls a DCM and a FCM corresponding to the disconnected device.

The application program is software for executing various processes. In the present example, the application program is software particularly for outputting controlling contents (functions) inputted through a GUI for controlling a virtual multi-connection device as a command which can be recognized by a Multi AVDISCFCM which is hereinafter described.

A DCM controls a device. The application program does not directly control the devices connected to the network, but controls the devices through such DCMs. A FCM represents contents (function) of control executed for a device by the application program and transmits an AV/C (Audio Video/Control) command to a device designated by a DCM. Since the DCM and the FCM function as an API, the application program itself need not consider differences among different devices. Accordingly, the network which adopts the HAVi allows a device on the network to recognize a function of another device on the network and can operate another device from a remote place.

A Multi AVDISCFCM is positioned intermediately between AVDISCFCMs 1 to 3 and the application program and synthetically manages the AVDISCFCMs 1 to 3. More particularly, the Multi AVDISCFCM synthetically controls and manages the AVDISCFCMs 1 to 3 in accordance with such commands as given in Table 1 below. Consequently, the application program can handle the devices (here, the MD drives 2 and 3) connected to the network through the Multi AVDISCFCM as a virtual single multi-connection apparatus.

<Table 1>

init initialization

getTable acquire an inner table

setTable set an inner table

getTrack acquire information for display of tracks which can be selected at present

setTrack set a track of a designated track number

getDisc acquire Disc information which can be selected at present

setDisc set a designated Disc number

sortTable perform sorting of an inner table (use

column header [0, 1, 2] as an argument, random or not (Boolean))

registerAVDISC add an MD on the network to a group of the multi-connection apparatus (argument: SEID)

unregisterAVDISC remove an MD on the network from a group of the multi-connection apparatus (argument: SEID)

Play play back a current disc, track

Stop stop playback of the virtual multi-connection MD

Pause Temporarily stop playback of the virtual multi-connection MD

RamdomPlay random playback of the virtual multi-connection MD

Setrepeat on/off setting of a repeat mode

ForwardTrack track forward of the virtual multi-connection MD

PreviousTrack Track reverse of the virtual multi-connection MD

Forward fast forward feed playback of the virtual multi-connection MD

Reverse fast reverse feed playback of the virtual multi-connection MD

Of the commands given above, “init”, “getTable” and “setTable” are described more specifically. “init” is a command from the application program to the Multi AVDISCFCM or an AVDISCFCM. The FCM described above executes a predetermined initialization process in accordance with the command “init”.

“getTable” is a command from the application program to the Multi AVDISCFCM or an AVDISCFCM. In accordance with the command “getTable”, the FCM described above returns information of an acquired inner table to the application program, and the application program produces a display screen based on the returned information.

“setTable” is a command from the application program to the Multi AVDISCFCM or an AVDISCFCM. In accordance with the command “setTable”, the FCM described above produces, if a corresponding apparatus possesses a recording medium, an inner table based on contents management information of the recording medium.

Therefore, when an inner table is to be displayed, “getTable” is executed after the “setTable”.

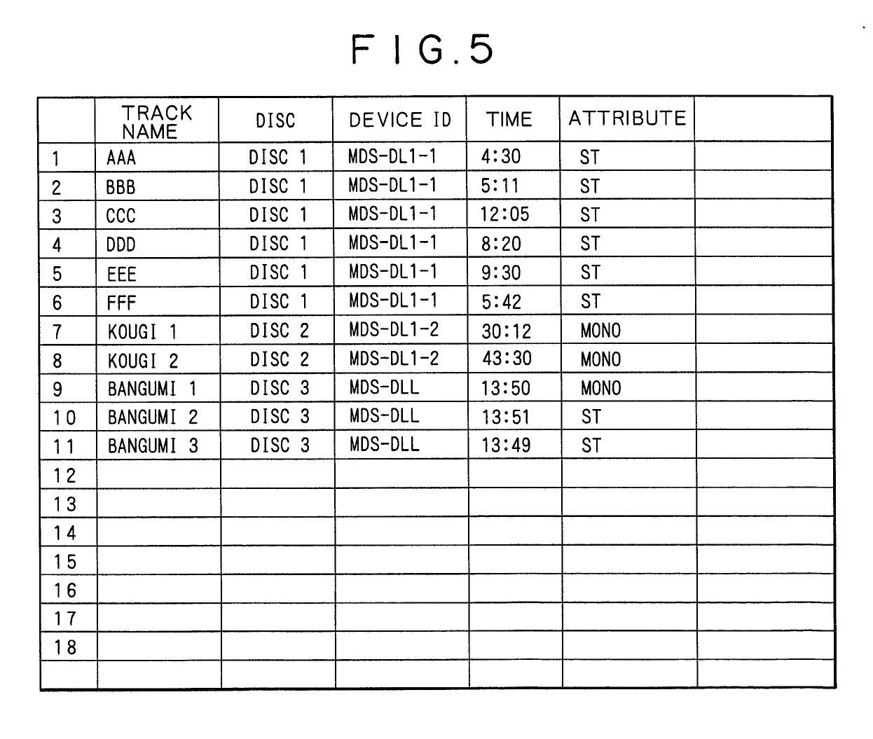

The inner table is a table produced by the Multi AVDISCFCM from tracks of MDs (TOC (Table of Contents)) read out from the AVDISCFCMs 1 to 3 as seen in FIG. 5. In the example of inner table shown in FIG. 5, the number of each track, a track name, a DISC, a device ID, time (recording time) and an attribute are recorded from the left side. As indications of the discs, DISC 1 to DISC 3 are given, and as the device ID, “MDS-DL1-1” is given for the DISC 1; “MDS-DL1-2” for the DISC 2; and “MDS-DLL” for the DISC 3. Since the MD drive 2 can accept two MDs, for example, “MDS-DL1-l” of the DISC 1 represents the MD 61, and “MDS-DL1-2” of the DISC 2 represents the MD 62.

For example, for the track number 1, “AAA” is recorded as the track name; “DISC 1” as the DISC name; “MDS-DL1-1” as the device ID; 4 minutes and 30 seconds are recorded as the recording time; and “ST” (which signifies stereo recording” as the attribute. On the other hand, for example, for the track number 8, “KOUGI 2” is recorded as the track NAME; “DISC 2” as the DISC name; “MDS-DL1-2” as the device ID; 43 minutes and 30 seconds are recorded as the recording time; and “MONO” (which signifies monaural recording” as the attribute.

Further, though not shown, the inner table further includes information for identification of types of recording media called HAVi media format. In the present example, identification information representative of a MD is recorded as the recording medium. Also it is possible to record information representative of recorded contents called MIC (Memory in Cassette) in the inner table.

Referring back to FIG. 4, an event manager is used to generate, if the state of the network changes typically because a new device is connected to the network or a device is disconnected from the network, an event and transmit the event to the other software modules. Consequently, plug-and-play can be realized with the network which adopts the HAVi.

A registry stores and updates information regarding the devices such as what devices are connected on the network or what functions the devices have, and allows mutual actions between different devices. The application program acquires necessary information (SEIDs and attribute information) from the registry. Further, each of the devices on the network can refer to the registry to confirm the locations of the basic software modules of the other devices on the network.

A stream manager supervises and manages a flow of stream data (continuous data) on the network to allow real-time transmission of stream data. Further, the stream manager manages connections in the devices and between the devices to secure or release network resources and provide connection information of the entire network. Further, the stream manager can support reconnection after resetting of the network.

A resource manager processes a problem of collision of the right of use of a device, manages scheduled events such as processes reserved for the connected devices and supervises the network to detect whether a device is disconnected after it is registered.

DCM 1 and DCN 2 correspond to devices installed from the MD drives 2 and 3, respectively. The AVDISCFCM 1 and the AVDISCFCM 2 are FCMs installed from the MD drive 2 and the AVDISCFCM 3 is a FCM installed from the MD drive 3 and corresponding to the respective devices.

Such software modules are possessed by the individual devices connected to the network in accordance with the classes of the devices prescribed by the HAVi. The HAVi prescribes four classes of devices.

A FAV (Full AV Device) corresponds to a device having a function of managing the network and includes all of the software modules of the HAVi described above (although it may sometimes possess no DCM and no FCM, they can be installed, for example, from a BAV which is hereinafter described). The FAV can execute an application which uses the Java (trademark) which is adopted as a HAVi byte code. Accordingly, the FAV can possess DCMs and FCMs of the other devices and can control the other devices by possessing the DCMs and the FCMs of the other devices.

An IAV (Intermediate AV Device) corresponds to a device which has a function of managing the network similarly to the FAV, but is different from the FAV in that it cannot execute an application which uses the Java (trademark) which is adopted as a HAVi byte code. Therefore, in order to control some other device, the IAV must incorporate the DCM and the FCM of the device in advance.

A BAV (Base AV Device) corresponds to a controlled device which can be connected directly to the network of the HAVi and posses the DCM and the FCM of the device itself. A LAV (Legacy AV Device) has a function only as a device which can be connected to the IEEE 1394 serial bus 4. Since the LAV is ready for AV/C commands, it can operate not only by itself but also as a controlled device.

Here, description is given of a case wherein the IRD 1 is a device corresponding to the FAV while the MD drives 2 and 3 are devices corresponding to the BAV. As seen in FIG. 4, the IRD 1 in the form of a FAV can place the MD drives 2 and 3 under the control thereof by installing the DCMs and the FCMs of the MD drives 2 and 3 all in the form of a BAV. Consequently, the IRD 1 which is a device for managing the HAVi network can produce connections to the MD drives 2 and 3, which are controlled devices, typically using the stream manager so that stream data may be flowed.

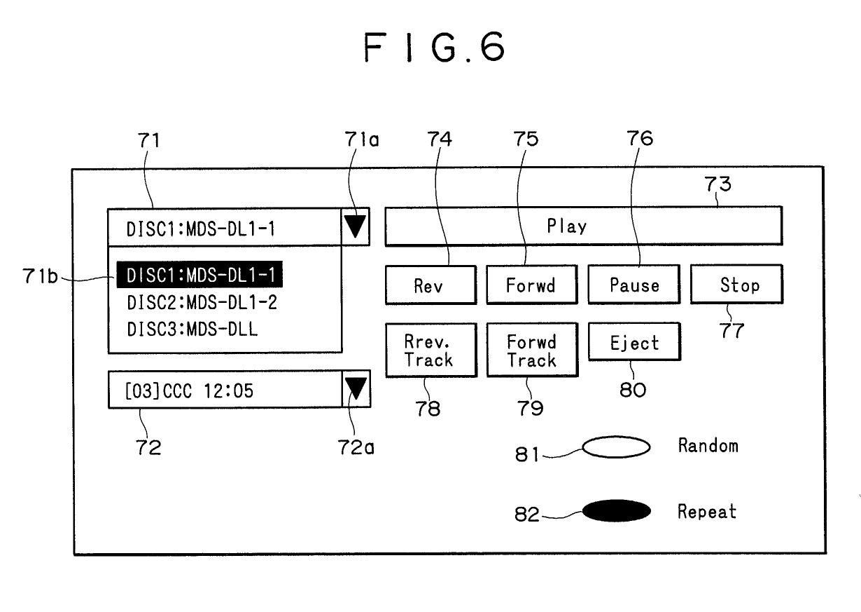

Now, GUIs (Graphical User Interfaces) of the IRD 1 displayed on the CRT 31 of FIG. 2 are described with reference to FIGS. 6 to 9. A GUI operates on the application program, and a command generated by operation of the GUI is issued to the Multi AVDISCFCM. The Multi AVDISCFCM sends instructions to the AVDISCFCMs 1 to 3 based on the command of Table 1 described hereinabove so that the AVDISCFCMs 1 to 3 issue AV/C commands to the MD drives 2 and 3 based on the instructions.

In a disc display column 71, discs which can be selected are indicated. If a cursor is moved to a button 71a and clicked, then a dropdown list 71b is displayed. In the dropdown list 71b, a list of discs which is recorded in the inner table of FIG. 5 and can be selected through the network is displayed. If a desired disc is selectively clicked from within the list, then the dropdown list 71b disappears, and the selected disc is displayed in the disc display column 71. In the example shown, “DISC1:MDS-DL1-1” is selected (displayed in void) from within the dropdown list 71b.

A track display column 72 is positioned below the disc display column 71. In the track display column 72, a track which is recorded on the disc (MD) of the disc display column 71 and selected at present is indicated, and its track name and recording time are indicated. If a button 72a is clicked, then a dropdown list 72b is displayed as seen in FIG. 7. The dropdown list 72b indicates contents of all tracks recorded on the disc of the disc display column 71. If a desired track is selectively clicked from within the dropdown list 72b, then this is displayed in the track display column 72. It is to be noted that, the dropdown list 72b disappears in response to the selection. In the example shown in FIG. 7, [03]CCC12:05 is selected (displayed in void).

A Play button 73 at a right upper portion of the GUI of FIG. 6 is used to cause the track indicated in the track display column 72 of the disc indicated in the disc display column 71 to be played back if the cursor is moved to the position of the Play button 73 and clicked. Below the Play button 73, a Rev (Reverse) button 74, a Forwd (Forward) button 75, a Pause button 76 and a Stop button 77 are positioned, and below the buttons 74 to 77, a Prev (Previous) Track button 78, a Forwd Track button 79 and an Eject button 80 are displayed. If the Rev button 74 is clicked, then the track being currently played back is played back in a fast rewound state while the Rev button 74 is kept clicked. If the Forwd button 75 is clicked, then the track being currently played back is played back in a fast fed state while the Forwd button 75 is kept clicked. If the Pause button 76 is clicked, then the playback is stopped temporarily, and when the Play button 73 is clicked again, playback is started from the temporary stop position. If the Stop button 77 is clicked, then the playback is stopped. If the Prev Track button 78 is clicked, then the playback point moves back to a track preceding to the current track and playback is started from the preceding track. The Forwd Track button 79 is operated in order to reversely move the playback point to the next track and start playback of the next track. The Eject button 80 is operated in order to input an instruction for removal of the disc indicated in the disc display column 71.

A Random button 81 changes its display color to black to place random playback into an on state if it is clicked once, but changes the display color back to white to place the random playback to an off state if it is clicked once again. When such random playback is in an on state, tracks of a designated disc are played back in an order rearranged at random. In the example shown in FIG. 6, the Random button 81 is displayed white, and therefore, random playback is in an off state.

A Repeat button 82 changes its display color to black to place repeat playback into an on state if it is clicked once, but changes the display color back to white to place the repeat playback to an off state if it is clicked once again. Such repeat playback causes the track designated in the track display column 72 to be played back repetitively. In the example shown, the Repeat button 82 is displayed black, and therefore, repeat playback is in an on state.

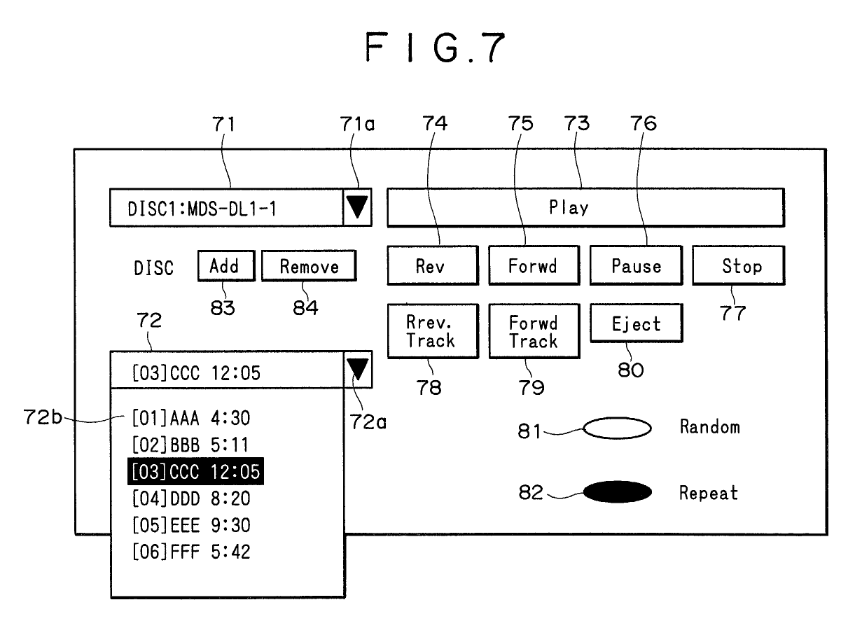

An additional registration button 83 having an indication “Add” in FIG. 7 is used to acquire all media information which can be acquired by the FCMs of the same type to produce an inner table. When the additional registration button 83 is clicked, the display screen changes from that of the GUI of FIG. 7 to that of a GUI of FIG. 8. If a desired disc is selected (clicked) from within a registerable disc display column 83a of the GUI of FIG. 8 and then a registration button 83b is clicked, then the selected disc is registered. Then, if an end button 83c is clicked, then the GUI of FIG. 7 is displayed with the registered disc updated.

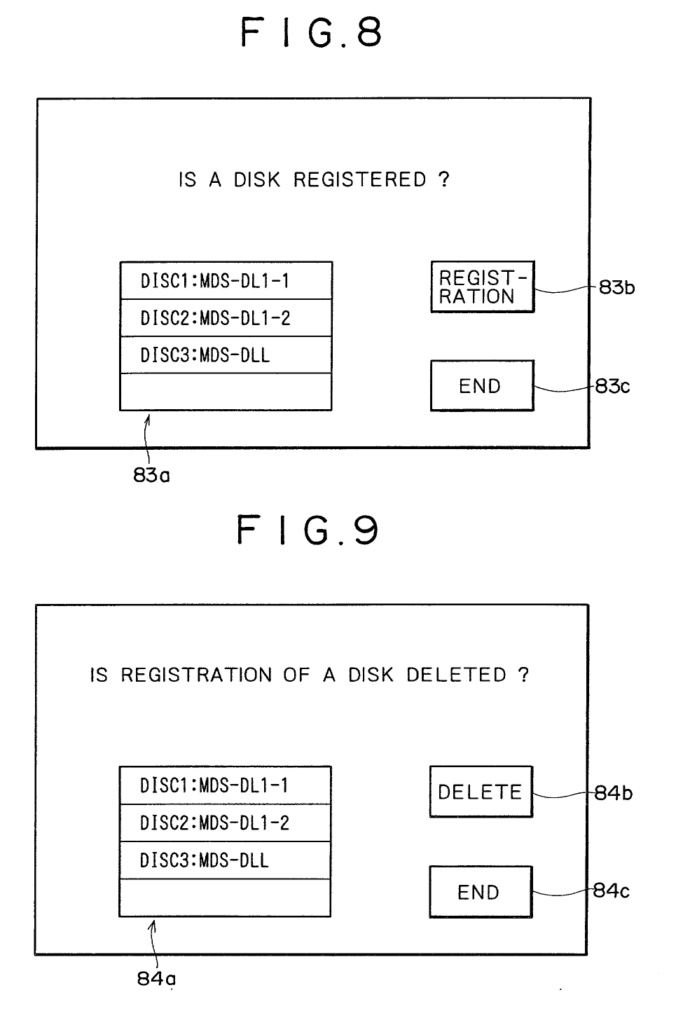

If a registration deletion button 84 having an indication “Remove” is clicked, then the screen display changes from that of the GUI of FIG. 7 to that of a GUI of FIG. 9. If a desired disc is selected (clicked) from within a deletion object disc display column 84a of the GUI of FIG. 9 and then a deletion button 84b is clicked, then the selected disc is deleted. Then, if an end button 84c is clicked, then the GUI of FIG. 7 is displayed with the deleted disc updated.

It is to be noted that, while the foregoing description relates to the GUIs in a multi-connection mode (mode in which a plurality of devices of the same type connected to each other over a network function like a single device), for example, if only the MD drive 3 is connected to the IRD 1 by the network, then since a plurality of devices of the same type are not connected, the button 71a is not displayed in the disc display column 71, and also the dropdown list 71b is not displayed.

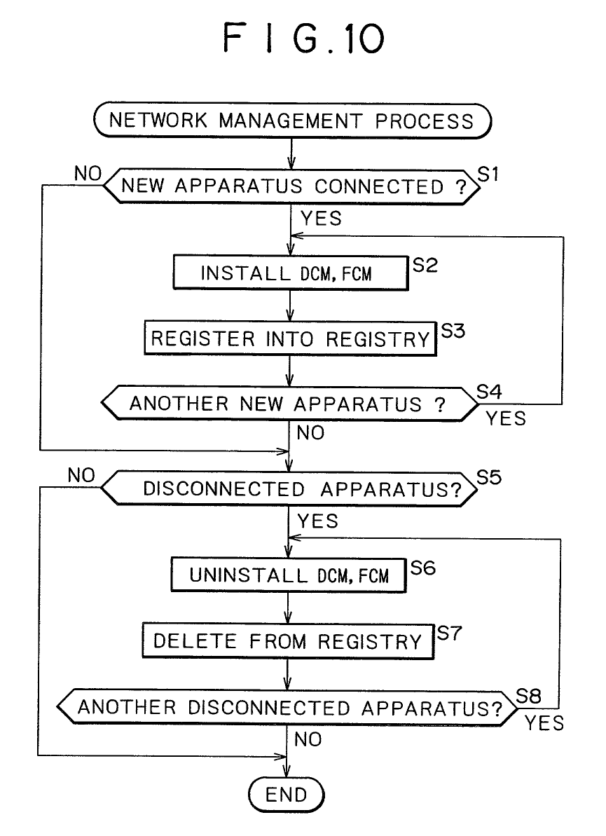

Now, a network management process executed by the IRD 1 is described with reference to a flow chart of FIG. 10. The network management process is executed without fail when bus resetting occurs because an apparatus is connected (plugged in) or disconnected (unplugged) to or from the network or main power supply to an apparatus connected to the network is connected or disconnected or from a like cause. Although specific description is omitted herein, the software modules described above with reference to FIG. 4 are read out from the hard disc drive 24 and executed by the CPU 26.

In step S1, the CMM discriminates whether or not a new device has been inserted into the network, that is, whether or not a new device has been connected to the network. If it is discriminated that a new device has been inserted, then the CMM notifies the DCM manager of such insertion of a new device through the event manager.

In step S2, the DCM manager installs a DCM and a FCM from the inserted new device, and then the processing advances to step S3. In the example illustrated in FIG. 10, since the MD drives 2 and 3 have been inserted newly, the DCMs 1 and 2 and the AVDISCFCMs 1 to 3 are installed from the MD drives 2 and 3.

In step S3, the event manager notifies, based on a message from the CMM, the individual software modules that a new device has been connected. The registry registers information regarding the newly connected devices based on the notification. In the present example, the event manager sends the notification that the MD drives 2 and 3 have been added newly, and the registry registers information regarding the MD drives 2 and 3.

In step S4, the event manager discriminates whether or not the network further has a new device. If it is discriminated that the network does not include a new device any more, the processing advances to step S5.

In step S5, the CMM and the resource manager discriminate whether or not a new device has been released from the network, that is, whether or not a device has been disconnected from the network.

If it is discriminated in step S5 that a new device has been released from the network, for example, if the MD drive 2 has been released, then the CMM notifies the event manager of such release, and the event manager notifies the software modules of such release. In step S6, the DCM manager unintalls the DCM 1, which is the DCM of the released MD drive 2, and the AVDISCFCMs 1 and 2 of the released MD drive 2 based on the notification.

In step S7, the registry erases the information of the MD drive 2. In step S8, the event manager discriminates whether or not another device has been removed from the network. If it is discriminated that no device has been removed, then the processing is ended.

If it is discriminated in step S1 that a new device has not been inserted, then the steps S2 to S4 are skipped and the processing advances directly to step S5. If it is discriminated in step S4 that there still exists a new device, then the processing returns to step S2.

If it is discriminated in step S5 that no device has been newly released from the network, then the steps S6 and S7 are skipped and the processing is ended immediately. On the other hand, if it is discriminated in step S8 that some device has been removed, then the processing returns to step S6 so that similar processing to that described above is repeated.

It is to be noted that the processing of installing a FCM and a DCM of a device and registering information of the device in steps S2 and S3 may be executed not only when a new device is inserted but also when power supply to, for example, any of the MD drives 2 and 3 is made available or when any of the MD drives 2 and 3 is plug-in connected. Further, the processing of uninstalling a FCM and a DCM of a device and erasing information regarding the device in steps S6 and S7 may be performed not only when a device incorporated is released but also when power supply to, for example, any of the MD drives 2 and 3 is disconnected or when any of the MD drives 2 and 3 is unplugged.

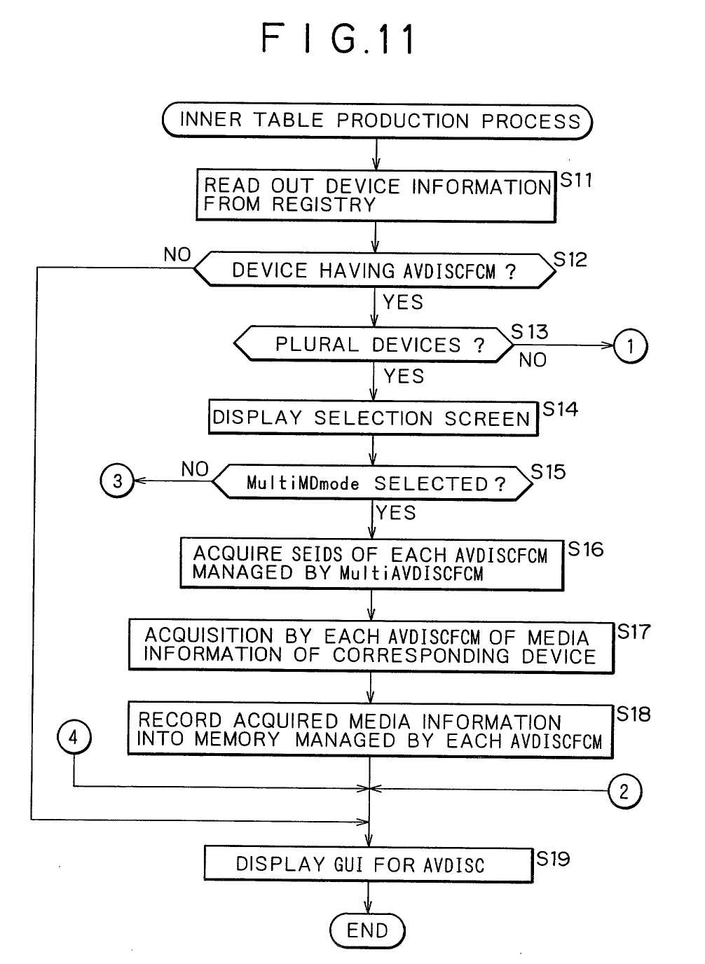

Subsequently, operation when the IRD 1 produces an inner table is described with reference to a flow chart of FIG. 11.

In step S11, the application program reads in information of the devices recorded in the registry.

In step S12, the application program discriminates based on the information of the registry read in whether or not the detected devices include a device which has a function of an ADVDISCFCM. In particular, the application program compares the types of the FCMs corresponding to the devices to discriminate the types of the devices thereby to discriminate whether or not the devices include a device which has a function of an AVDISCFCM. In the present example, the MD drives 2 and 3 are devices which have a function of an AVDISCFCM, and therefore, it is discriminated that the devices include a device which has a function of an AVDISCFCM, and the processing advances to step S13.

In step S13, the application program discriminates whether or not a plurality of devices have been detected. In the present example, the MD drives 2 and 3 are devices which have a function of an AVDISCFCM. Therefore, it is discriminated that a plurality of devices have been detected. Then, the processing advances to step S14.

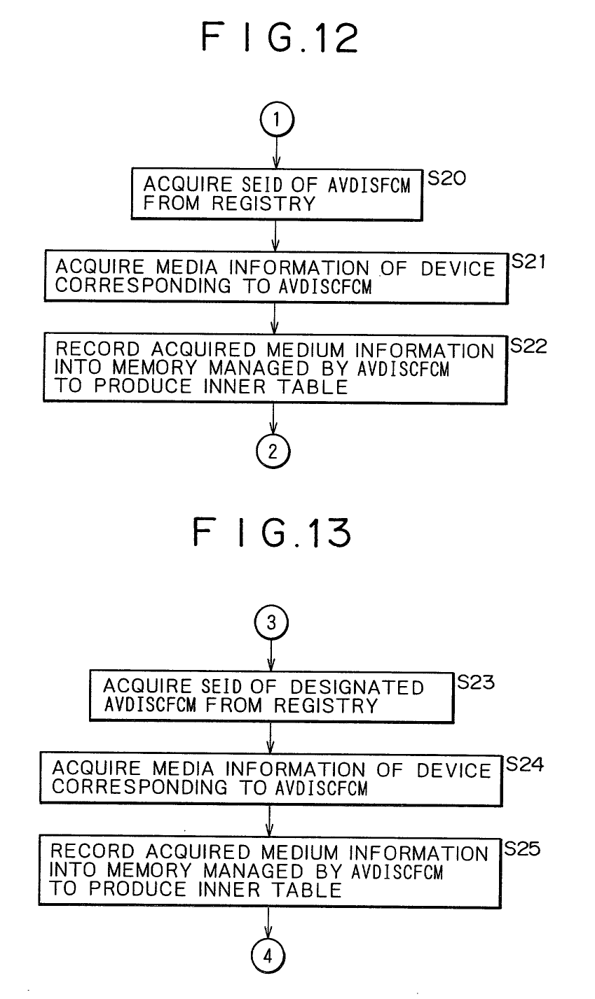

In step S14, the application program causes such a selection screen as shown in FIG. 14 to be displayed.

In step S15, the application program discriminates whether or not the MultiMD in FIG. 14 is selected. For example, if the MultiMD is selectively clicked, then the application program outputs the command setTable to the Multi AVDISCFCM, and then the processing advances to step S16.

In step S16, the application program acquires the SEIDs of the AVDISCFCMS managed by the Multi AVDISCFCM. In step S17, the Multi AVDISCFCM outputs a command for acquiring media information to the AVDISCFCMs based on the setTable command from the application program and acquires such information from the AVDISCFCMs if media are loaded in the corresponding devices.

In step S18, the media information acquired is stored into the memories managed by the AVDISCFCMs and an inner table is produced. In particular, in step S18, the Multi AVDISCFCM issues the AvDISC::GetFormat command (a command of the HAVi specifications) to the AVDISCFCMs 1 to 3 in order to read in media information recorded on the discs of the detected devices. The AVDISCFCMs 1 to 3 output AV/C commands for instruction for reading in of the media information of the discs of the MD drives 2 and 3 to the MD drives 2 and 3 based on the AvDISC::GetFormat command. In response to the AV/C commands, the MD drives 2 and 3 read in the media information from the MDs and output the media information to the AVDISCFCMs 1 to 3. The AVDISCFCMs 1 to 3 receive the media information read out from the MD drives 2 and 3 and send the media information to the Multi AVDISCFCM. Then, the Multi AVDISCFCM produces an inner table based on the read out media information.

Consequently, when the application program outputs the getTable command to the Multi AVDISCFCM in step S19, the Multi AVDISCFCM reads out the information of the inner table and returns the information to the application program. Then, the application program controls the monitor 11 to display such a GUI as shown in FIG. 6 based on the received information of the inner table.

If it is discriminated in step S12 that the detected devices do not include a device which has a function of an AVDISCFCM, then the application program causes the indication “NO AVDISC” to be displayed in the disc display column 71 of FIG. 6. Then, after a fixed time elapses, the processing is ended.

If it is discriminated in step S13 that a plurality of devices having a function of an AVDISCFCM are not detected, then the application program acquires the SEID of the single AVDISCFCM in step S20 of FIG. 12. Then in step S21, the AVDISCFCM acquires media information based on the setTable command from the application program if a medium is loaded in the device. In step S22, the acquired media information is stored into the memory managed by the AVDISCFCM and an inner table is produced. Then, the processing advances to step S19.

Referring back to FIG. 11, if it is discriminated in step S15 that the multiMD is not selected, then the application program acquires the SEID of the AVDISCFCM of the designated MD drive in step S23 of FIG. 13. Then in step S24, the AVDISCFCM of the designated MD drive acquires media information based on the setTable command from the application program if a medium is loaded in the device. In step S25, the acquired media information is stored into the memory managed by the AVDISCFCM of the designated MD drive and an inner table is produced. Then, the processing advances to step S19. In other words, a GUI for the multi-connection mode is not displayed. However, if only the MD drive 2 is detected, then since the MD drive 2 can accept two MDs, the button 71a is displayed on the display of the GUI.

It is to be noted that the inner table production process may be executed to produce an inner table each time the Multi AVDISCFCM detects on/off of power supply to a device, plugging/unplugging of a device, loading/unloading of a MD onto/from a device, or writing onto or erasure from a disc.

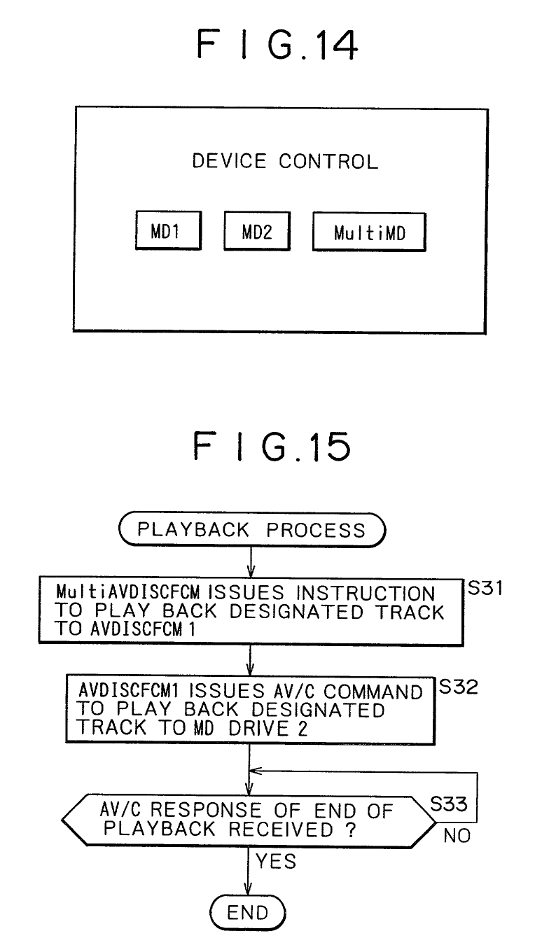

Now, operation when a predetermined track is to be played back from a display of the GUI of FIG. 6 is described with reference to a flow chart of FIG. 15.

Tue processing of the flow chart is started when the user operates the touch panel 23 based on the display of the GUI to move the cursor to the Play button 73 and then click it.

An instruction for a playback operation is inputted from the application program to the Multi AVDISCFCM, and the Multi AVDISCFCM issues the Play command to play back a track designated with the GUI, in the present case, [03] :CCC12:05, to the AVDISCFCM 1 in step S31. Then, the processing advances to step S32.

In step S32, the AVDISCFCM 1 outputs an AV/C command for instruction of playback of the designated track to the MD drive 2 in accordance with the received Play command.

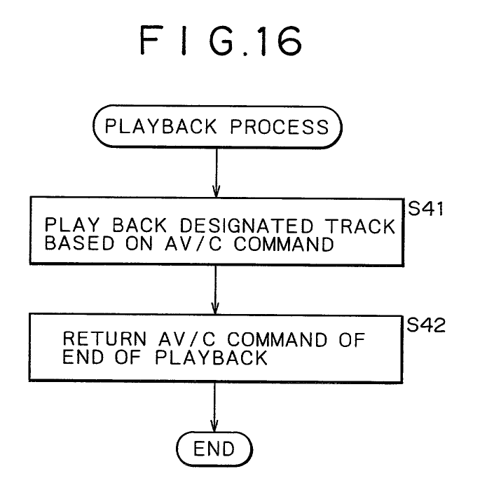

Here, operation of the MD drive 2 when the AV/C command for instruction of playback is received is described with reference to a flow chart of FIG. 16. When the AV/C command for playback is received, the MD drive 2 starts its processing. In particular, in step S41, the CPU 55 of the MD drive 2 controls the recording and playback section 53 to play back an MD (device ID: the MD 61 which corresponds to MDS-DL1-1) in accordance with the AV/C command for playback inputted through the IEEE 1394 serial bus 4, IEEE 1394 interface 58 and internal bus 54.

In step S42, when the playback comes to an end, the CPU 55 outputs an AV/C response of completion of playback to the IRD 1 through the internal bus 54, IEEE 1394 interface 58 and IEEE 1394 serial bus 4. Then, the processing is ended. It is to be noted that, also in the following description, the MD drive 2 or 3 executes a similar playback operation, and therefore, overlapping description of such playback operation is omitted herein to avoid redundancy.

Referring back to FIG. 15, in step S33, the Multi AVDISCFCM discriminates whether or not an AV/C response has been received. If it is discriminated that no AV/C response has been received, then the Multi AVDISCFCM repeats the processing in step S33 and thereby enters and keeps a waiting state for reception of an AV/C response.

If it is discriminated in step S33 that an AV/C response of completion of playback has been received, then the processing is ended.

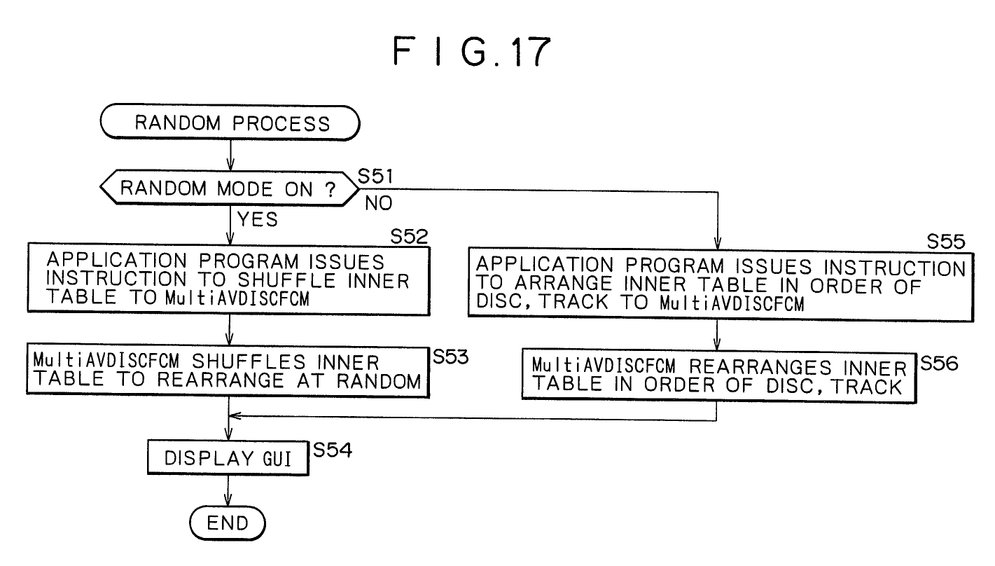

Now, operation of the IRD 1 when the Random button 81 is operated to an on/off state on the GUI of FIG. 6 to establish a black/white display state is described with reference to a flow chart of FIG. 17.

The processing of the flow chart is started when the user operates the touch panel 23 to click the Random button 81 of the GUI on the application program in the state illustrated in FIG. 6.

In step S51, the application program discriminates whether the random mode is on or off as a result of the clicking of the Random button 81. For example, if it is discriminated that the random mode is on, then the processing advances to step S52.

In step S52, the application program sends the command sortTable() to the Multi AVDISCFCM to instruct the Multi AVDISCFCM to shuffle the tracks of the inner table, that is, to rearrange the order of the tracks. Then, the processing advances to step S53.

In step S53, the Multi AVDISCFCM shuffles the tracks of the inner table to rearrange them in accordance with the instruction from the application program. Then, the processing advances to step S54.

In step S54, the application program updates the disc display column 71 and the track display column 72 of the GUI of FIG. 7 based on the inner table and causes the updated GUI to be displayed, whereafter the processing is ended.

If it is discriminated in step S51 that the random mode is not on, then the application program issues an instruction to the Multi AVDISCFCM to rearrange the inner table in order of the discs and the tracks in step S55.

In step S56, the Multi AVDISCFCM rearranges the inner table in order of the discs and the tracks in accordance with the instruction from the application program. Then, the processing advances to step S54 so that the processing described above is performed.

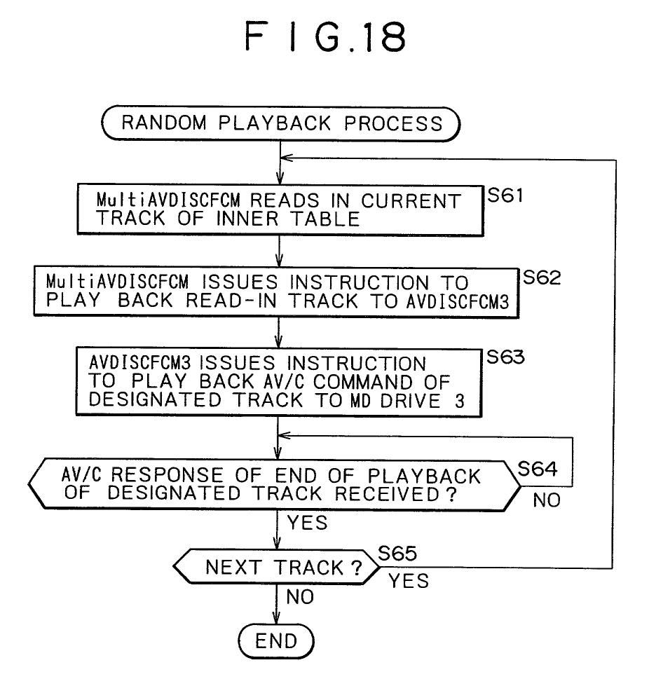

Now, operation when the MD drive 2 plays back in the random-on state after the process of FIG. 17 when the random mode is on, that is, the processing in steps S51 to S54, is described with reference to a flow chart of FIG. 18.

The processing of the flow chart of FIG. 18 is started when the user operates the touch panel 23 to move the cursor to the Play button 73 and click it in response to the display of the GUI.

When an instruction for a playback operation is inputted from the application program as a result of the clicking of the Play button 73, the Multi AVDISCFCM reads in a current track of the inner table in step S61.

In step S62, the Multi AVDISCFCM issues the Play command, for example, if the current track is in the AVDISCFCM 3, to the AVDISCFCM 3 of the current track to play back the track read in. Then, the processing advances to step S63.

In step S63, the AVDISCFCM 3 outputs an AV/C command for instruction of playback of the designated track to the MD drive 3 in accordance with the received Play command.

In step S64, the Multi AVDISCFCM discriminates whether or not an AV/C response of completion of playback has been received from the MD drive 3. If it is discriminated that no AV/C response has been received, then the Multi AVDISCFCM repeats the processing in step S64 and thereby enters and keeps a state in which it waits for reception of an AV/C response until an AV/C response of completion of playback is received. Then, when it is discriminated that an AV/C response has been received, the processing advances to step S65.

In step S65, the Multi AVDISCFCM refers to the rearranged inner table to discriminate whether or not there is a next track. If it is discriminated in step S65 that there is a next track, then the processing returns to step S61 so that similar processing to that described above is repeated. On the other hand, if it is discriminated in step S65 that there is no next track, then the processing is ended.

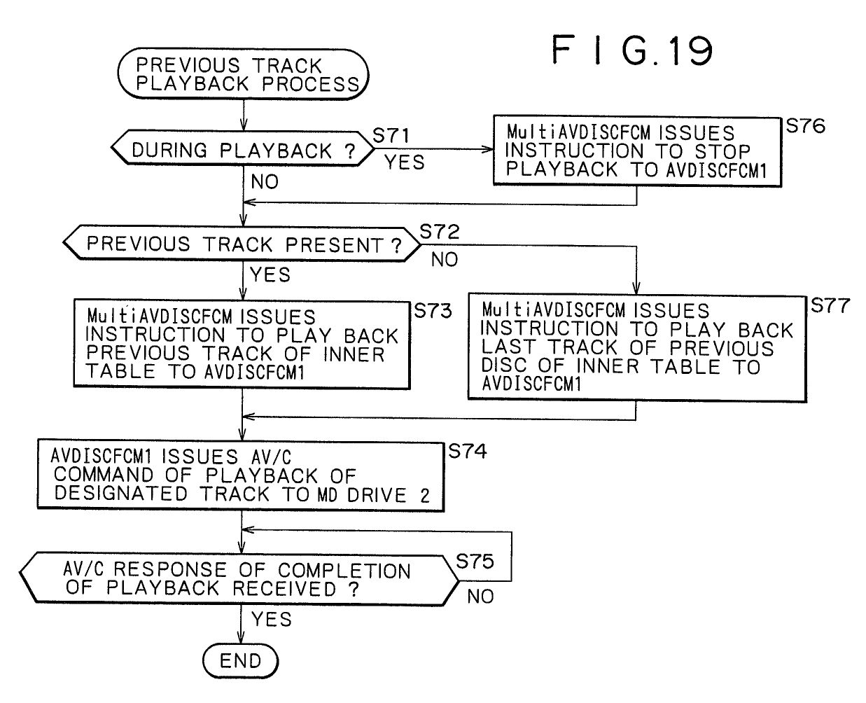

Subsequently, a process of the IRD 1 for changing the track to be played back to the just preceding track is described with reference to a flow chart of FIG. 19.

The process of FIG. 19 is started when the user operates the touch panel 23 to move the cursor to the Prev Track button 78 of the GUI on the application program shown in FIG. 6 and click it.

When a signal representative of the operation of the Prev Track button 78 is received from the application program, the Multi AVDISCFCM discriminates in step S71 whether or not the designated device is playing back. If it is discriminated in step S71 that the designated device is not playing back, then the processing advances to step S72.

In step S72, the Multi AVDISCFCM refers to the inner table to discriminate whether or not the preceding track is present. For example, if the currently designated tack is [03]CCC12:05 and another track [02]BBB5:11 is present as the preceding track, then it is discriminated that the preceding track is present, and the processing advances to step S73.

In step S73, the Multi AVDISCFCM refers to the inner table to output the PreviousTrack command for playback of the preceding track [02]BBB5:11 to the AVDISCFCM 1. Then, the processing advances to step S74.

In step S74, the AVDISCFCM 1 outputs an AV/C command for playback of the track [02]BBB5:11 of the DISC 1 of the MD drive 2, which is a device designated to the DCM 1, to the MD drive 2.

The MD drive 2 executes the process illustrated in the flow chart of FIG. 16 in accordance with the AV/C command.

In step S75, the Multi AVDISCFCM discriminates whether or not an AV/C response of completion of playback has been received from the MD drive 2. If it is discriminated that no AV/C response has been received, then the Multi AVDISCFCM repeats the processing in step S75 and thereby enters and keeps a response waiting state until an AV/C response of completion of playback is received. Then, when it is discriminated that an AV/C response has been received, the processing is ended.

If it is discriminated in step S71 that the designated disc is being played back, then the processing advances to step S76, in which the Multi AVDISCFCM sends the Stop command to stop playback to the AVDISCFCM 1. The AVDISCFCM 1 outputs an AV/C command to stop playback in accordance with the received Stop command, whereafter the processing advances to step S72 so that similar processing to that described above is performed.

If it is discriminated in step S72 that the preceding disc is not present as a result of referring to the inner table, then the processing advances to step S77, in which the Multi AVDISCFCM issues the Play command for playback of the last track of the disc of the preceding device ID to the AVDISFCM 1. Thereafter, the processing advances to step S74 so that similar processing to that described above is performed.

It is to be noted that, although the operation when the track to be played back is changed to the preceding track is described above, similar processing is performed also when the track to be played back is changed to the next track. On the other hand, if there is no preceding track and besides there is no preceding disc in step S72, then the preceding track playback process is ended.

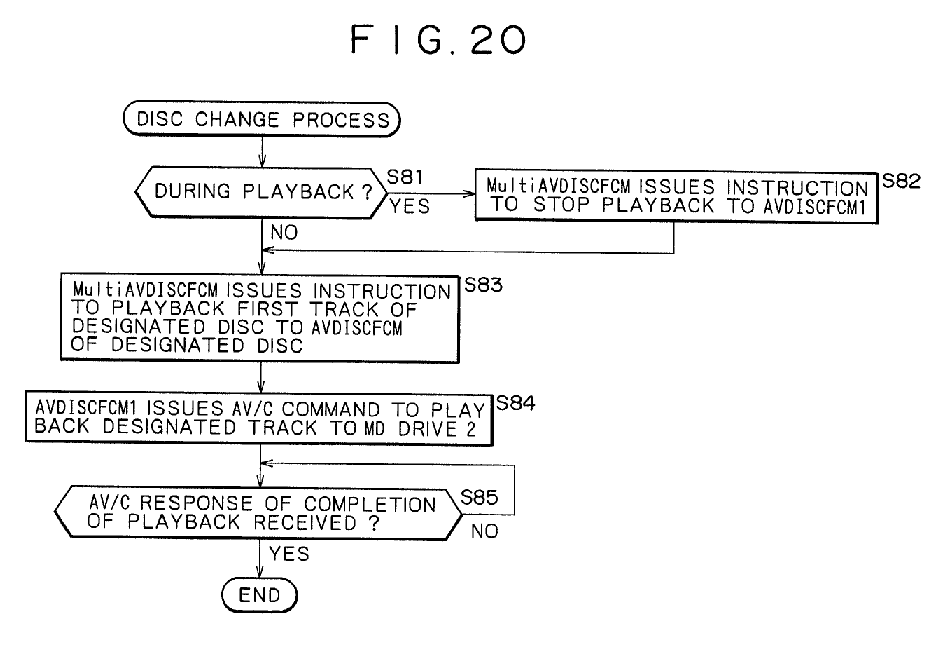

Now, operation of the IRD 1 when a disc is to be changed is described with reference to a flow chart of FIG. 20. The process is started when the user operates, for example, the touch panel 23 to click the button 71a of the GUI on the application program of FIG. 6, move the cursor from the currently designated DISC 1: MDS-DL1-1 to the DISC 2: MDS-DL1-2 (move the position displayed in void) and click it and then click the Play button 73.

In step S81, the Multi AVDISCFCM discriminates whether or not the DISC 1 is being played back. If it is discriminated that the DISC 1 is being played back, then the processing advances to step S82, in which the Multi AVDISCFCM sends the Stop command to the AVDISCFCM 1. In response to the Stop command, the AVDISCFCM 1 issues an AV/C command for stopping of playback to the MD drive 2, whereafter the processing advances to step S83. On the other hand, if it is discriminated in step S81 that the DISC 1 is not being played back, then the processing skips step S82 and advances directly to step S83.

In step S83, the Multi AVDISCFCM refers to the inner table to output the Play command for playback of the first track “KOUGI1” of the designated DISC 2 to the AVDISCFCM 2. Then, the processing advances to step S84.

In step S84, the AVDISCFCM 2 outputs an AV/C command for playback of the track “KOUGI1” to the MD drive 2. Then, the processing advances to step S85.

In response to the command, the MD drive 2 executes the process of the flow chart of FIG. 16.

In step S85, the AVDISCFCM 2 discriminates whether or not an AV/C response of completion of playback has been received. If it is discriminated that no AV/C response has been received, then the AVDISCFCM 2 repeats the processing in step S85 and thereby enters and keeps a response waiting state. Then, if an AV/C response of completion of playback is received, then the processing is ended.

It is to be noted that, although operation when the disc to be played back is changed to the immediately next disc is described above, it similarly applies also when the disc to be played back is changed to the immediately preceding disc. In this instance, when the disc to be played back is to be changed over from the DISC 1 to the preceding disc, it is changed to the DISC 3.

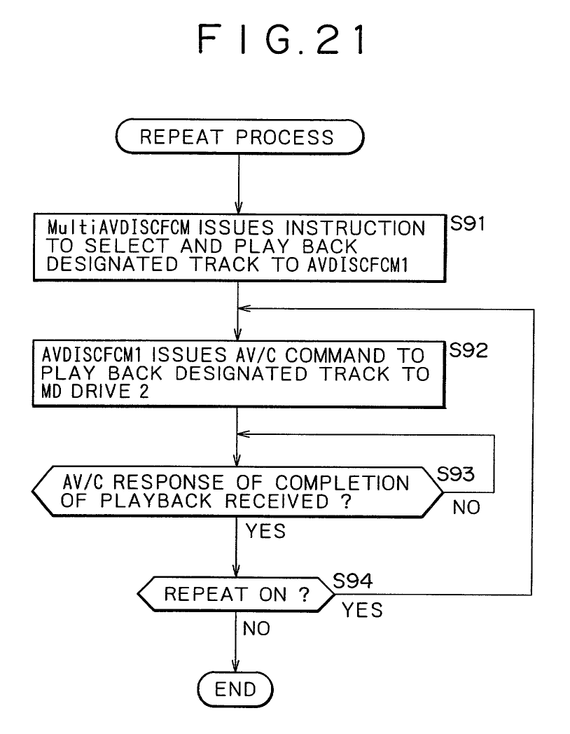

Subsequently, playback operation of the IRD 1 when the Repeat button 82 is clicked to turn on repeat playback is described with reference to a flow chart of FIG. 21. When the user operates the touch panel 23 to click the Repeat button 82 of the GUI on the application program of FIG. 6, an instruction to turn on repeat playback is sent to the Multi AVDISCFCM. The Multi AVDISCFCM sets a Repeat flag to on based on the information to turn on repeat playback from the application program. If the Play button 73 is clicked in this state, then the process illustrated in FIG. 21 is started.

In step S91, the Multi AVDISCFCM selects a track designated by the application program from within the inner track and issues the Play command for playback of the designated track to the AVDISCFCM (for example, the AVDISCFCM F1) corresponding to the track. Then, the processing advances to step S92.

In step S92, the AVDISCFCM 1 outputs an AV/C command for playback of the designated track to the MD drive 2.

The MD drive 2 executes the process of the flow chart of FIG. 16 in accordance with the AV/C command.

In step S93, the CPU 26 of the IRD 1 discriminates whether or not an AV/C response of completion of playback has been received. If it is discriminated that no AV/C response has been received, then the CPU 26 of the IRD 1 repeats the processing in step S93 and thereby enters and keeps a response waiting state. Then, if an AV/C response of completion of playback is received, then the processing advances to step S94.

In step S94, the Multi AVDISCFCM discriminates whether or not the Repeat flag is on. In the present example, the Repeat flag has been set on as described above. Therefore, the processing discriminates that the Repeat flag is on, and consequently, the processing returns to step S92 so that similar processing to that described above is repeated.

If it is discriminated in step S94 that the Repeat flag is not on, that is, the Repeat flag has been set to off, then the processing is ended.

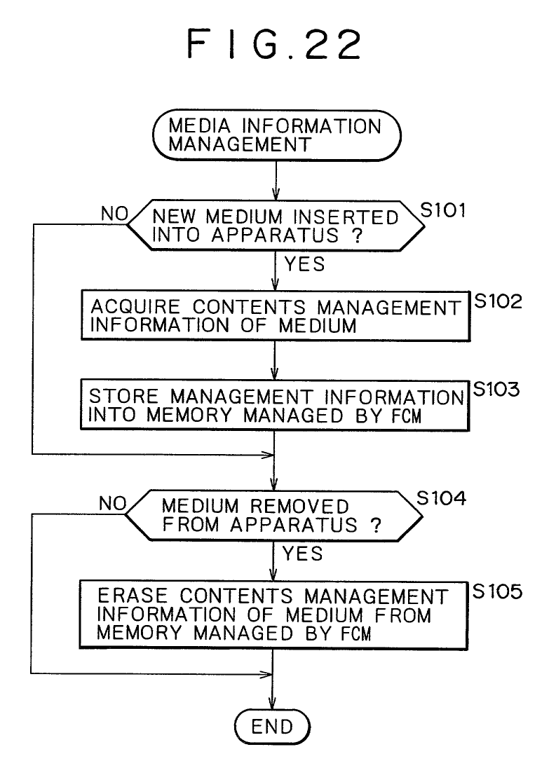

Now, a media information management process is described with reference to a flow chart of FIG. 22.

In step S101, the event manager discriminates whether or not a medium (recording medium) has been inserted newly (including whether or not main power supply has been connected or whether or not bus resetting has occurred). If it is discriminated that a medium has been inserted newly, then the event manager notifies the FCM of such insertion of a new medium.

In step S102, the application program acquires contents management information from the newly inserted medium. In step S103, the application program stores the acquired contents management information into the memory managed by the FCM. In step S104, the event manager discriminates whether or not a medium has been removed from an apparatus (including whether or not main power supply has been disconnected or whether or not bus resetting has occurred) If it is discriminated that a medium has been removed from an apparatus, then the media information of the medium is erased from the memory managed by the FCM in step S105.

If it is discriminated in step S101 that a medium has not been inserted newly, then the processing advances to step S104. If it is discriminated in step S104 that a medium has not been removed from an apparatus, then the processing is ended.

While the foregoing description relates to operation upon playback, operation upon recording can be executed by similar processing to that described above. Further, where two information apparatus connected to each other are set so that one of the information apparatus plays back while other information apparatus records, also such processing as dubbing can be performed.

Further, the foregoing description is given of an example wherein a plurality of information apparatus of the same type are MD drives. However, the information apparatus may be any information apparatus by which recording or playback of information onto or from a recording medium such as a magnetic recording medium, an optical recording medium, a magneto-optical recording medium or a semiconductor recording medium can be performed. For example, a DV (Digital Video) recording and/or playback apparatus, a VHS (Video Home System) recording and/or playback apparatus, a S-VHS (Super-Video Home System) recording and/or playback apparatus, a CD (Compact Disc) drive, a DVD (Digital Versatile Disc) drive, a D-VHS (Digital-Video Home System) recording and/or playback apparatus or a Hi8 recording and/or playback apparatus may be used in place of a MD derive, or a plurality of different types of such information apparatus as mentioned above may be connected.

While the series of processes described above can be executed by hardware, it may otherwise be executed by software. Where the series of processes is executed by software, a program which constructs the software is installed from a program storage medium into a computer incorporated in hardware for exclusive use or, for example, a personal computer for universal use which can execute various functions by installing various programs.

The program storage medium is formed not only as the hard disc drive 27 which is provided to a user while it is incorporated in the IRD 1 as seen in FIG. 2 and in which the program is recorded but also as a package medium such as a magnetic disc 44 (including a floppy disc), an optical disc 43 (including a CD-ROM (Compact Disc-Read Only Memory) and a DVD (Digital Versatile Disc)), a magneto-optical disc 42 (including an MD (Mini-Disc)), or a semiconductor memory 41 which is distributed to provide the program to a user and in or on which the program is recorded.

It is to be noted that, in the present application, the steps which describe the program recorded in or on a program storage medium may be but need not necessarily be processed in a time series in the order as described, and include processes which are executed parallelly or individually without being processed in a time series.

It is to be noted that, in the present application, the term “system” is used to signify an entire apparatus composed of a plurality of apparatus.

While a preferred embodiment of the present invention has been described using specific terms, such description is for illustrative purposes only, and it is to be understood that changes and variations may be made without departing from the spirit or scope of the following claims.

What is claimed is:

1. An information processing apparatus, comprising:
recording medium information acquisition means for acquiring information of recording media loaded in a plurality of information apparatus connected to each other by a network;
storage and management means for storing and managing the information of the recording media acquired by said recording medium information acquisition means in a concentrated manner; and
control means for controlling said plurality of information apparatus based on the information of the recording media stored in said storage and management means.

2. An information processing apparatus according to claim 1, further comprising control information acquisition means for acquiring control information to be used to control said plurality of information apparatus individually from said information apparatus through said network, and wherein said control means controls said plurality of information apparatus based on the control information acquired by said control information acquisition means.

3. An information processing apparatus according to claim 1, wherein the recording media only allow playback thereof or allow both of recording and playback thereof.

4. An information processing apparatus according to claim 1, wherein said network is formed from an IEEE 1394 serial bus.

5. An information processing apparatus according to claim 1, further comprising:
display means for displaying the information of the recording media stored in said storage and management means; and
selection means for selecting the information of the recording media displayed on said display means;
said control means controlling said information apparatus in response to those contents of the information of the recording media displayed on said display means which have been selected by said selection means.

6. An information processing apparatus according to claim 1, wherein, when power supply to any of said information apparatus is connected, when any of said information apparatus is plug-in connected, when a recording medium is loaded into any of said information apparatus or when contents are recorded onto any of the recording media, said storage and management means stores the information of the recording medium acquired by said recording media information acquisition means.

7. An information processing apparatus according to claim 1, wherein, when power supply to any of said information apparatus is disconnected, when any of said information apparatus is unplugged, when a recording medium is unloaded from any of said information apparatus or when contents are erased from any of the recording media, said storage and management means erases the information of the recording medium stored therein.

8. An information processing apparatus according to claim 1, wherein the information of each of the recording media is recorded contents management information of the recording medium and includes a device ID, track numbers, track names, recording times, a HAVi media format or a MIC.

9. An information processing apparatus according to claim 1, further comprising apparatus type information acquisition means for acquiring apparatus type information of said plurality of information apparatus connected to each other by said network.

10. An information processing apparatus according to claim 9, wherein the type of each of said information apparatus is identified with a type of a FCM of the same.

11. An information processing apparatus according to claim 1, wherein said plurality of information apparatus include information apparatus of the same type.

12. An information processing method, comprising:
a recording medium information acquisition step of acquiring information of recording media loaded in a plurality of information apparatus connected to each other by a network;
a storage and management step of storing and managing the information of the recording media acquired by the processing of the recording medium information acquisition step in a concentrated manner; and
a control step of controlling said plurality of information apparatus based on the information of the recording media stored by the processing of the storage and management step.

13. A program storage medium in which a computer-readable program is recorded, the program comprising:
a recording medium information acquisition controlling step of controlling acquisition of information of recording media loaded in a plurality of information apparatus connected to each other by a network;
a storage and management controlling step of controlling storage and management of the information of the recording media acquired by the processing of the recording medium information acquisition controlling step in a concentrated manner; and
a control step of controlling said plurality of information apparatus based on the information of the recording media stored by the processing of the storage and management controlling step.
